(19) United States
(12) Patent Application Publication
(10) Pub. No.: US 2008/0231884 A1
(43) Pub. Date: Sep. 25, 2008

(54) IMAGE FORMING APPARATUS WHICH HAS A FAX FUNCTION

(75) Inventor: Naoto Okazaki, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/689,772

(22) Filed: Mar. 22, 2007

(51) Int. Cl. G06F 15/00

(52) U.S. Cl. 358/1.15

(57) ABSTRACT

An ifax communication unit that performs communication of image data through the Internet, which is mounted on an image forming apparatus, includes a destination address table, which is stored in a memory unit, for setting original scanning resolution to resolution defined by a protocol of the Internet. While setting of the scanning resolution is valid, when a user selects transmission of image data by an ifax transmission (E-MAIL) mode, even if the original scanning resolution is set to another resolution in a FAX mode, the resolution is changed to the resolution defined by the protocol and original scanning and transmission is performed.

### BACKGROUND OF THE INVENTION

1. Field of the Invention

The present invention relates to an image forming apparatus having a fax function with which, when facsimile is communicated through the Internet, an image is scanned with resolution of image scanning switched to resolution conforming to a protocol set in advance and transmitted.

2. Description of the Related Art

In recent years, business machines have been improved to have multiple functions. Image forming apparatus having a copy function, a printer function, and a fax function, and the like such as a multifunction complex electronic copying apparatus described in JP-A-2001-238063 is known.

For example, a complex electronic copying apparatus 100 shown in FIG. 6 is mounted with, as fax functions, for example, a FAX communication unit that performs transmission and reception of image data through a normal telephone network and an Internet Fax (ifax) communication function for performing transmission and reception of image data through a server and the Internet. This Internet Fax is a communication system for transmitting and receiving image data using the server and the Internet in accordance with a protocol of the Internet and belongs to the category of E-MAIL.

The FAX communication function includes a destination address book in which destinations of plural partners registered by a user are filed in order to eliminate the trouble of the user having to key-input a destination (a FAX number indication or an ifax address) every time the user performs facsimile transmission. The FAX communication function causes a display panel to display this destination address book and collectively performs input of destinations according to selection and instruction such as icon selection and button depression.

In a destination address book shown in FIG. 4B, if both a FAX number and an ifax address are registered for one user destination, two buttons, i.e., [FAX] and [ifax] buttons, are displayed as the user destination to make it possible to select the buttons. (For example, 007 uiteam 1 shown in FIG. 4B)

This apparatus is mounted with a scanner mechanism for image data scanning incidental to the fax communication function. This scanner mechanism can select resolution (an image quality) of an image at the time of scanning according to a request of the user. By selecting an “OPTION” button shown in FIG. 4B, the user shifts to a screen in FIG. 4C.

As shown in FIG. 4C, for example, as additional functions at the time of FAX transmission, in general, there are plural modes such as a [U-FINE (ultra-fine)] mode, a [FINE (fine)] mode, and a [STANDARD (ordinary)] mode as setting of resolution. One of the modes is selected out of the modes.

In transmission by the normal [FAX] mode, an original to be transmitted is scanned at resolution (any one of ultra-fine, fine, and ordinary) set by the user and transmission processing is executed at the resolution. In general, as resolution is set higher, original scanning time and time required for transmission are longer.

On the other hand, transmission by the [ifax] mode is executed in accordance with protocols of the Internet and the server used. In other words, in ifax, image data is transmitted at the resolution of, for example, 200 dpi in accordance with an ifax protocol. Therefore, when resolution for original scanning set by the user is set to resolution equal to or higher than that defined by the ifax protocol, for example, ultra-fine of 400 dpi, an original is scanned at the resolution set. At the time of transmission, the image (image data) scanned at the resolution is converted into the resolution conforming to the ifax protocol and transmitted.

In the normal [FAX] mode, image data is scanned at resolution set by the user and the image data of the resolution is transmitted and received. On the other hand, in the [ifax] mode, image data is converted into the resolution (e.g., 200 dpi “fine”) conforming to the ifax protocol determined in the Internet. In other words, even if an original is scanned at the resolution of ultra-fine 400 dpi according to a desire of the user, actually, since an image quality is adjusted to an ifax protocol image quality before transmission, image data read is degraded to a fine 200 dpi level.

Therefore, an image is degraded from the ultra-fine level to the fine level and an image quality is deteriorated and, in addition, an original scanning time is longer at the ultra-fine level compared with the fine level. Moreover, time for performing image conversion at the time of transmission is added. These extra times are useless times and are causes of transmission delay. When the image quality of the image data is converted from ultra-fine to fine using software, it is likely that a (rough) image inferior to the image quality scanned at the fine level originally.

### BRIEF SUMMARY OF THE INVENTION

The present invention provides an image forming apparatus having a fax communication function including an image generating unit that generates image data from an original in which information is described, a FAX communication unit that communicates the image data through a telephone network, an ifax communication unit that communicates the image data through the Internet, and a control unit that includes a destination address table in which communication conditions including plural desired resolutions in the image data and resolution defined by a protocol of the Internet are set. The image forming apparatus has a fax communication function in which, when communication by the ifax communication unit is instructed, the resolution defined by the protocol is applied to resolution of scanning of the original by the image generating unit and the image data to be transmitted.

Moreover, the present invention provides an image forming method in an image forming apparatus having a fax communication function including generating, using an image generating unit, image data from an original in which information is described and communicating the image data through the Internet using an ifax communication unit. In the image forming method, without operation for changing resolution by a transmitting person, using a destination address table in which communication conditions including resolution defined by a protocol of the Internet are set, resolution defined by the protocol is applied to resolution of scanning of the original by the image generating unit and the image data to be transmitted instead of resolution set originally.

### BRIEF DESCRIPTION OF THE SEVERAL VIEWS OF THE DRAWING

FIG. 1 is a diagram showing a block structure of an image forming apparatus having a fax communication unit according to an embodiment of the invention;

FIGS. 2A, 2B, 2C, and 2E are display examples of an operation panel and a screen (a touch panel) at the time of initial setting of ifax scanning processing;

FIG. 3 is a flowchart for explaining the initial setting of the ifax scanning processing;

FIGS. 4A, 4B, 4C, and 4E are display examples of an operation panel and a screen at the time of transmission processing of the ifax scanning processing;

FIG. 5 is a flowchart for explaining the transmission processing of the ifax scanning processing; and

FIG. 6 is a diagram showing an external structure of a multifunction complex electronic copying apparatus.

### DETAILED DESCRIPTION OF THE INVENTION

An embodiment of the invention will be hereinafter explained in detail with reference to the drawings.

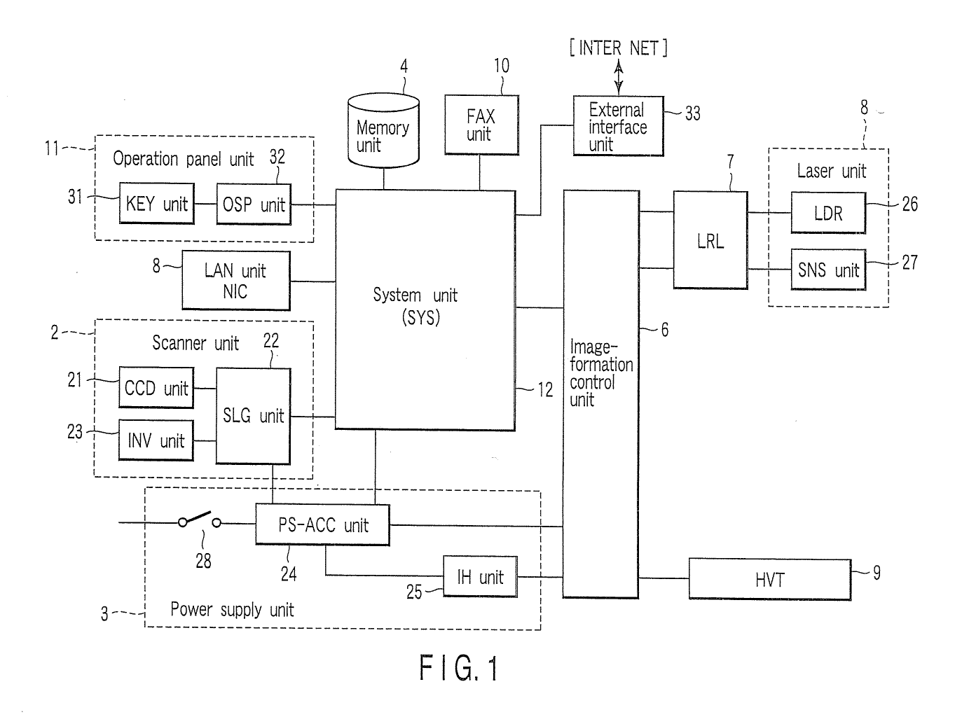

FIG. 1 shows a block structure of an image forming apparatus having a fax communication unit according to an embodiment of the invention.

An image forming apparatus 1 is constituted by a scanner unit 2 serving as an image generating unit that optically scans information (characters, numerals, patterns, pictures, etc.) described in an original and generates an electric signal (image data), a power supply unit 3 that supplies driving power to respective components, a memory unit 4 that stores programs, application software, and a destination address table described later, a LAN (Local Area Network) unit 5, an image formation control unit (LGC) 6, and an LRL 7 (no explanatory diagram is included in the material received), a laser unit 8 that irradiates a laser beam for recording, a high-voltage generating (HVT) unit 9, a FAX unit 10 that transmits and receives image data through a telephone network, an operation panel unit 11, a system (SYS) unit 12 serving as a control unit that controls the respective components, and an external interface unit 13 for performing communication (mainly packet communication) with external apparatuses through a server of the Internet. In the image forming apparatus 1 in this embodiment, only the components necessary for explanation of the gist of the invention are shown. Besides, the image forming apparatus 1 has components provided in a normal multifunction complex electronic copying apparatus such as a recording sheet conveying mechanism and a recording sheet storing tray.

The scanner unit 2 is constituted by an imaging unit (a CCD unit) 21, a scanning-function control unit (an SLG unit) 22, and an exposure control unit (an INV unit) 23. The CCD unit 21 is constituted by an imaging device (a CCD) that converts reflected light reflected on a data describing surface of an original into an electric signal, an A/D converter, and the like. In this embodiment, video signals (analog signals) of three colors (red, green, and blue) are generated from the reflected light according to photoelectric conversion of the imaging device and the video signals of the respective colors are converted into digital signals, respectively, by the A/D converter and, then, combined to generate image data of a certain fill format. The SLG unit 22 is a unit that mainly controls an entire scanning function (scanner driving mechanism). The SLG unit 22 is constituted by a scanner CPU, image-processing control units (ASICs), and a data rewritable memory (e.g., a flash ROM or an SRAM). When an original is scanned, light emission and scanning operation of an exposure lamp are driven according to a command from the scanner CPU. Image processing of the video signals read by the CCD unit 21 is executed by the respective ASICs. The INV unit 23 includes a control circuit that controls light emission of the exposure lamp. Luminance control (adjustment of a light emission amount) for the exposure lamp is performed according to a command from the scanner CPU.

The power supply unit 3 is constituted by a DC-voltage generating unit (a PS-ACC unit) 24, a coil-driving-voltage generating unit (an IH unit) 25, and a power supply switch 28. Besides, although not shown in the figure, the power supply unit 3 includes an overcurrent protection circuit including a fuse and a breaker for detecting an overcurrent and protecting the apparatus, an interlock switch for isolating the power supply in order to detect opening, closure, and the like of an apparatus cover and prevent danger for a user, and the like. The PS-ACC unit 24 generates a DC driving voltage for driving the respective components in the apparatus from AC power supplied from the outside. The IH unit 25 generates electric power for driving an IH coil of a not-shown Fuser unit from the AC power input using a switching regulator.

The memory unit 4 is mainly constituted by a mass storage such as a built-in hard disk drive (HDD). As a supplement to the mass storage, the memory unit 4 includes semiconductor memories such as a RAM, a ROM, and a flash ROM. Besides, the memory unit 4 may include an external recording device that records information in removable recording media such as an external HDD and a memory card.

The LAN unit 5 connects the image forming apparatus 1 to plural personal computers and peripheral apparatuses through a LAN (wire or wireless) and performs data communication.

The LGC unit 6 mainly controls an image forming function (an image forming engine or a printer engine). This LGC unit 6 is constituted by an engine CPU, ASICs, a memory (e.g., a flash ROM, an SRAM, or an NVRAM), and the like. The engine CPU controls the respective ASICs to drive I/Os (electric portions) of respective sections in the system. There relate to operation of the laser unit 8, other not-shown components (a revolver, a developer unit, a drum, a transfer belt, a drawer, a bypass unit, and an ADU (a unit that relays signals among electric driving units (a motor, a sensor, a clutch, etc.))), and the like.

The laser unit 8 is constituted by a light emitting unit (an LDR unit) 26 and a laser-radiation-position detecting unit (an SNS unit) 27. The LDR unit 26 is constituted by a laser diode and an ASIC. A laser beam is emitted and radiated on the basis of an output image data signal from the ASICs in the image formation control unit. The SNS unit 27 includes an optical sensor for detecting a position on which the laser is radiated. This optical sensor outputs an H-synchronous signal to a PWM (pulse width modulator) on the LGC unit 6.

The HVT unit 9 generates a high voltage of, for example, 24 V, in order to supply driving power to a not-shown main charger, developer, and conveying mechanism, respectively.

The operation panel unit 11 is constituted by a keyboard unit (a KEY unit) 31 and a liquid crystal display unit and display control unit (a DSP unit) 32. The KEY unit 31 is constituted by, for example, a button switch or a key provided on a control panel and respective LED display units. Alternatively, the KEY unit 31 is constituted by a touch panel provided on a display unit screen of the DSP unit 32. The DSP unit 32 includes a panel processing CPU that processes an instruction input signal from the respective buttons or the key and a backlight control unit for the liquid crystal display unit. The DSP unit 32 performs processing and control of an instruction signal inputted by the button switch, the key, or an icon and relays a control signal of the control panel from the SYS unit 12 to the liquid crystal display unit and the KEY unit 31.

The SYS unit 12 is constituted by a system CPU, ASICs, a memory (e.g., a DIMM, a flash ROM, an SRAM, or an NVRAM), an RTC (a real time clock IC), and the like. This system CPU controls all the components. Specifically, the system CPU performs scanning control for image data, image processing including various kinds of correction for the image data, input and output control for image memories (a page memory, a main memory, and an HDD), registration and setting change for the destination address table, communication and control processing by the external interface unit (BASE-T/TX of 10/100, USB, PCI, and IEEE1284) 13, and control of the respective ASICs related to the FAX communication processing. On the basis of an input instruction or input data from the control panel, the system CPU communicates with the SLG unit 22 in the LGC unit 6 and the scanner CPU in the engine CPU and, then, outputs operation commands to the scanner unit and the image formation control unit.

Operations of the image forming apparatus 1 constituted as described above will be explained.

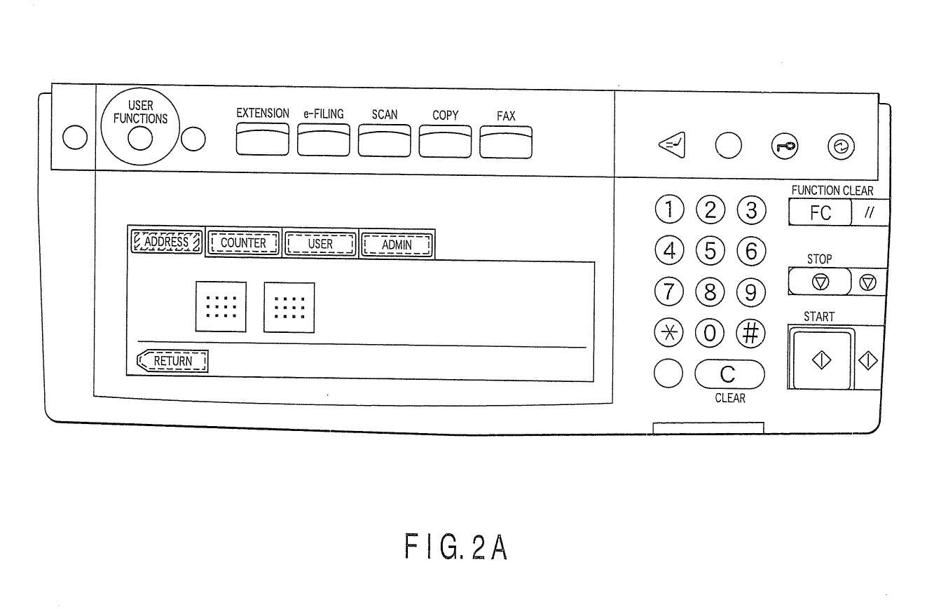

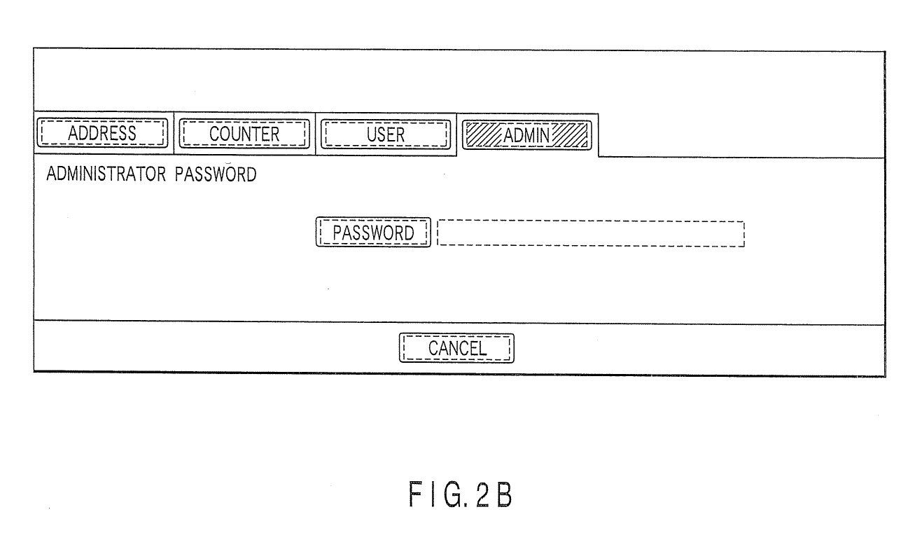

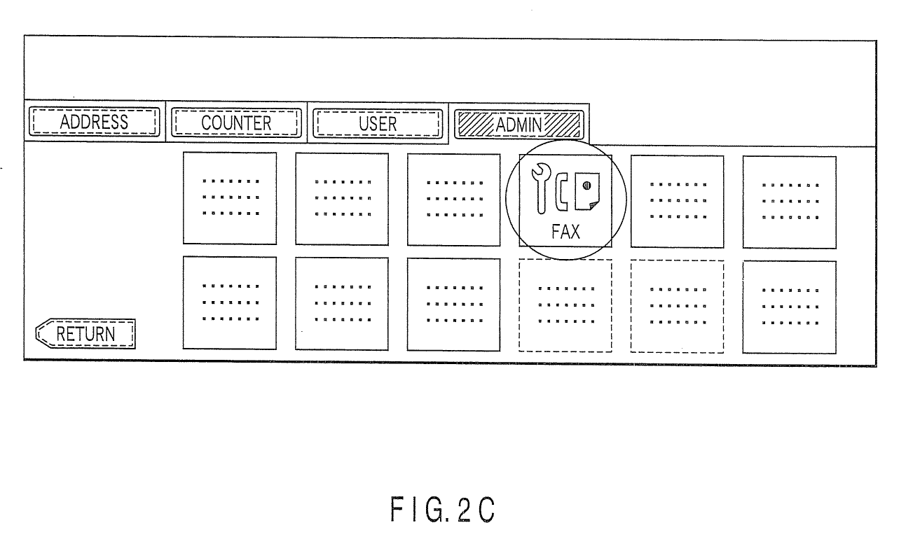

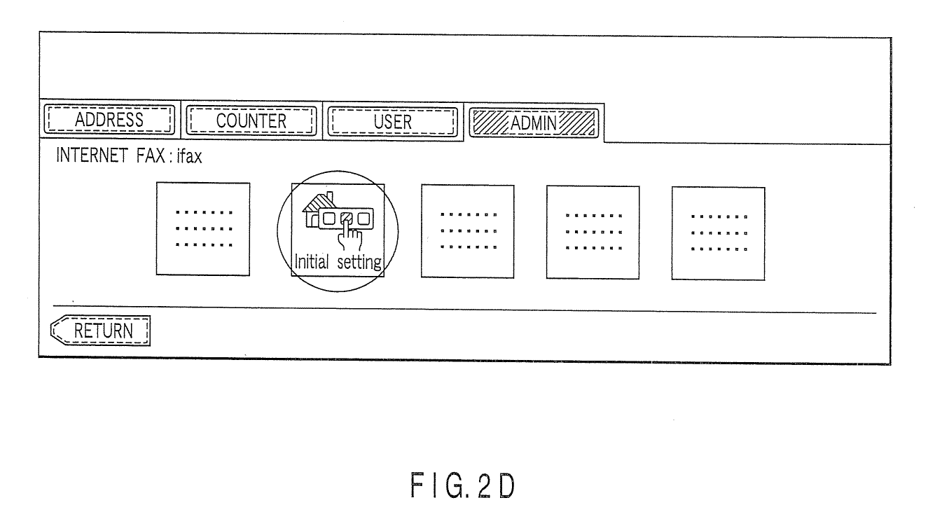

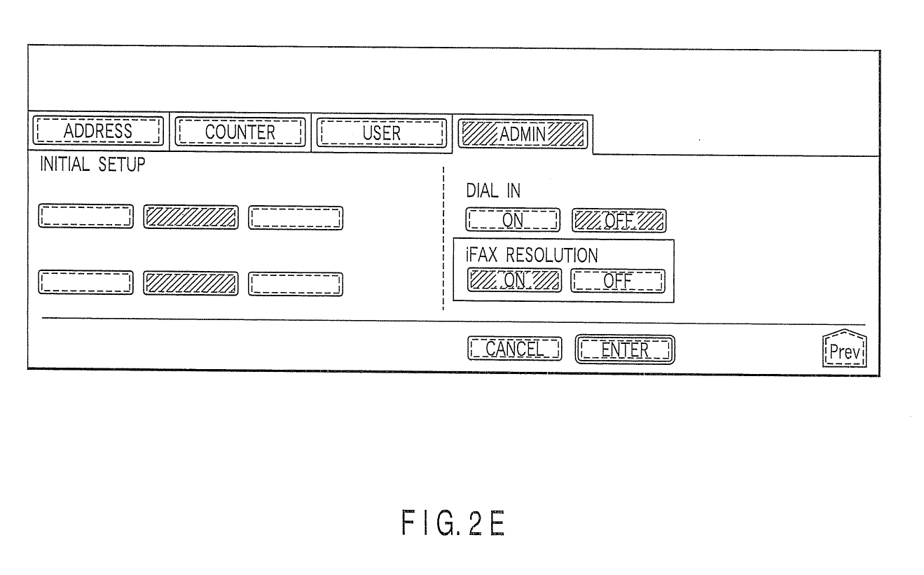

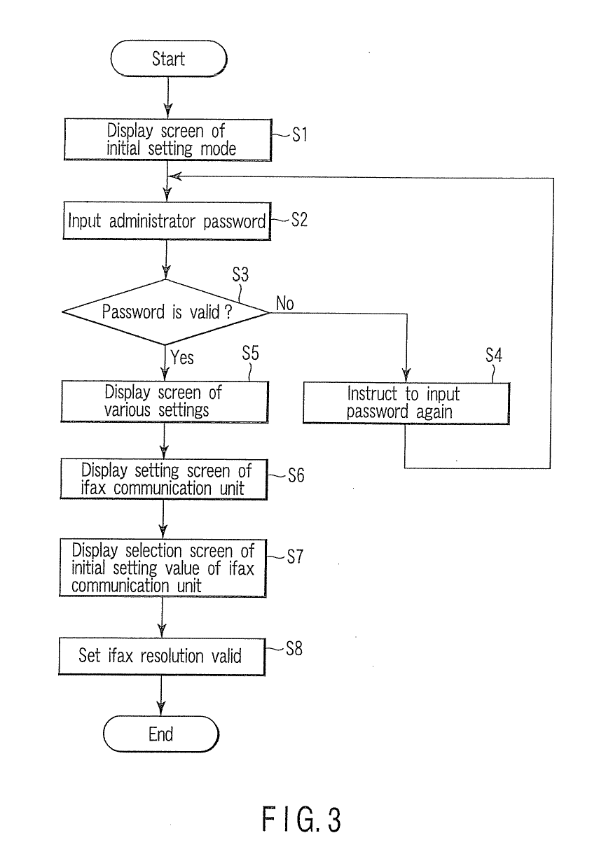

First, initial setting of ifax scanning processing will be explained with reference to display examples of an operation panel and a screen (a touch panel) shown in FIGS. 2A to 2E and a flowchart shown in FIG. 3.

As shown in FIG. 2A, on a normal screen (not shown), a user depresses a [USER FUNCTION] button arranged in an upper part of the operation panel to cause the image forming apparatus 1 to display a screen of an initial setting mode (step S1). Subsequently, the user depresses a [tab] button displayed in an upper part of the screen shown in FIG. 2B to cause the image forming apparatus 1 to display an administrator setting screen and inputs an administrator password consisting of numerals and characters (step S2). The image forming apparatus 1 determines whether the password inputted is valid (step S3).

When the password is valid in this determination (YES), the image forming apparatus 1 permits screen operation. On the other hand, when the password is not valid (NO), the image forming apparatus 1 indicates that the password is wrong (using display, buzzer sound, etc.) and urges the user to input a password again (step S4). When a password is inputted again, the image forming apparatus 1 shifts to step S3 and performs determination again. The image forming apparatus 1 may be set to cancel, when input mistakes occur plural times, for example, twice, acceptance of operation after that and return to the normal screen.

When this screen operation is set valid, a setting screen on which functional icons for performing setting of various functions shown in FIG. 2C are arranged is displayed (step S5). The user touches an [INTERNET FAX] icon displayed on this setting screen and causes the image forming apparatus 1 to display a setting screen of the ifax communication unit shown in FIG. 2D (step S6). The user touches an [INITIAL SETUP] icon in this setting screen to display an initial value selection screen of the ifax communication unit (step S7). In this selection screen, in order to set resolution, the user selects [ON] of an [ifax RESOLUTION] item to set the ifax scanning processing valid (give priority to the ifax scanning processing) (step S8) and touches [ENTER] to finish the setting.

It is a characteristic in this embodiment that [ifax RESOLUTION] is provided in [INITIAL SETUP]. In this [ifax RESOLUTION], according to selection of [ON], resolution is fixed to resolution defined by the protocol in the Internet, for example, 200 dpi [detail]. According to this setting, when the user performs transmission operation for ifax, resolution in original scanning processing is set to 200 dpi [detail] automatically, i.e., without user operation. At this point, operation for changing the resolution to resolution of 400 dpi [ultra-fine] is not accepted and the resolution is fixed to 200 dpi [detail]. In [ifax RESOLUTION], when [OFF] is selected, resolution is set as conventionally and it is possible to scan an original at desired resolution. However, at the time of transmission, the resolution is changed to the resolution defined by the protocol in the Internet. For example, even if the original is scanned at the resolution of 400 dpi “ultra-fine”, when the user designates transmission by ifax, the image forming apparatus 1 converts the resolution into the resolution defined by the protocol consuming a conversion time. When the original is scanned at resolution lower than the resolution defined by the protocol, image data is transmitted in a state of image data at the low resolution.

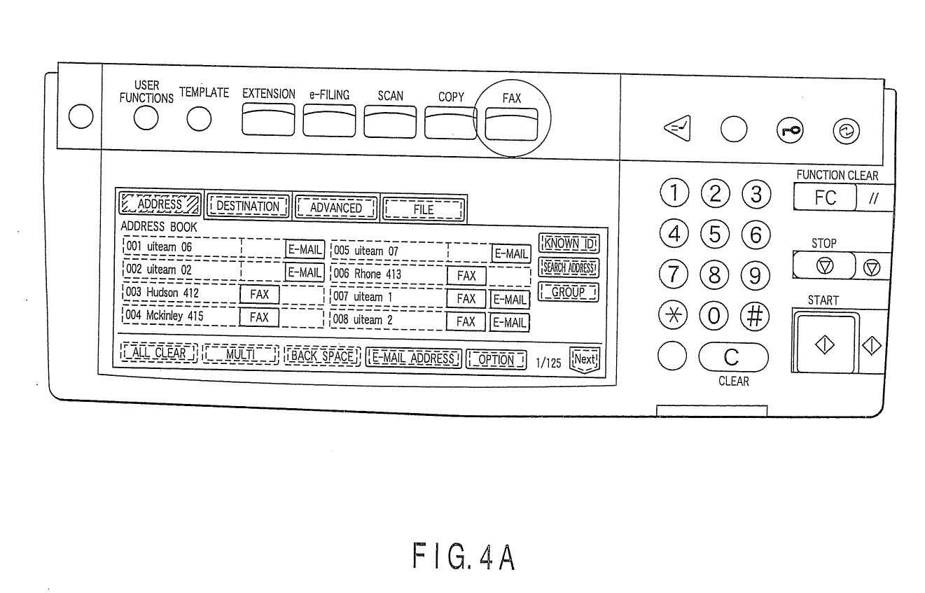

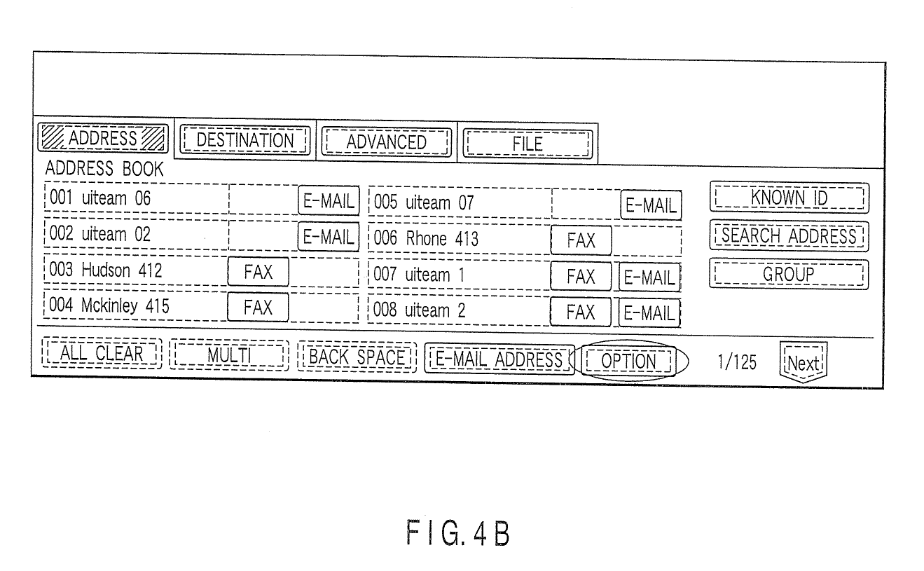

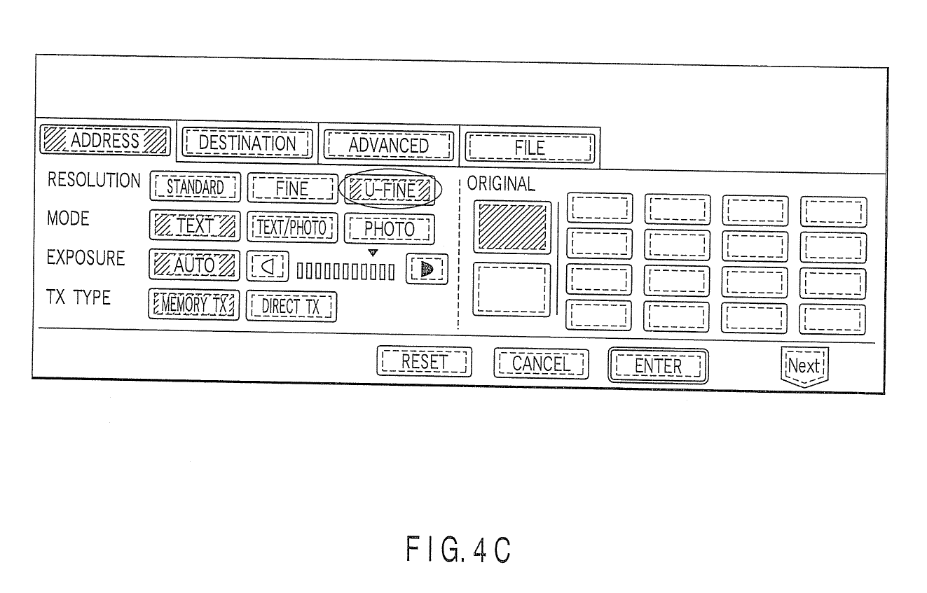

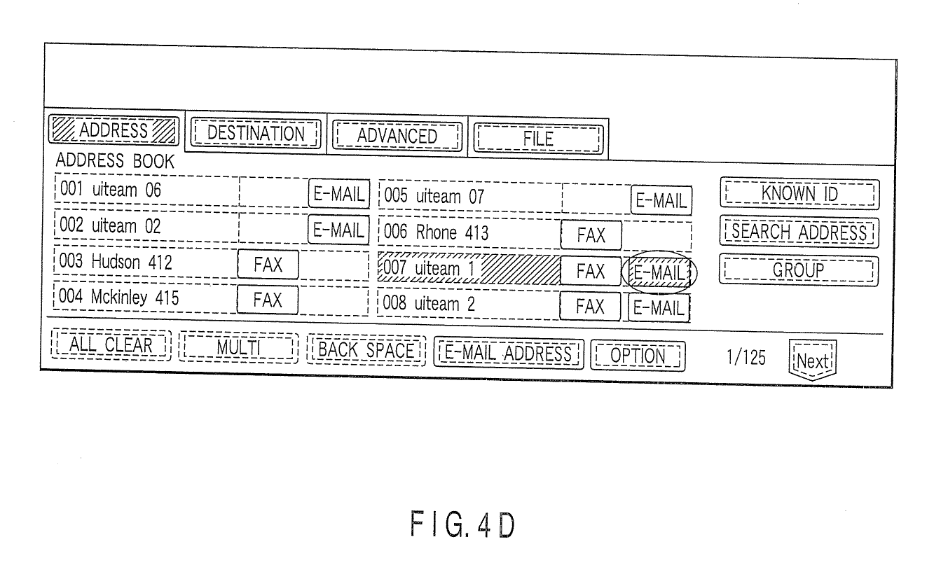

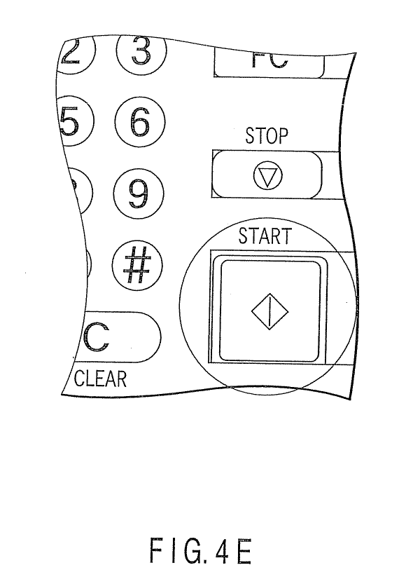

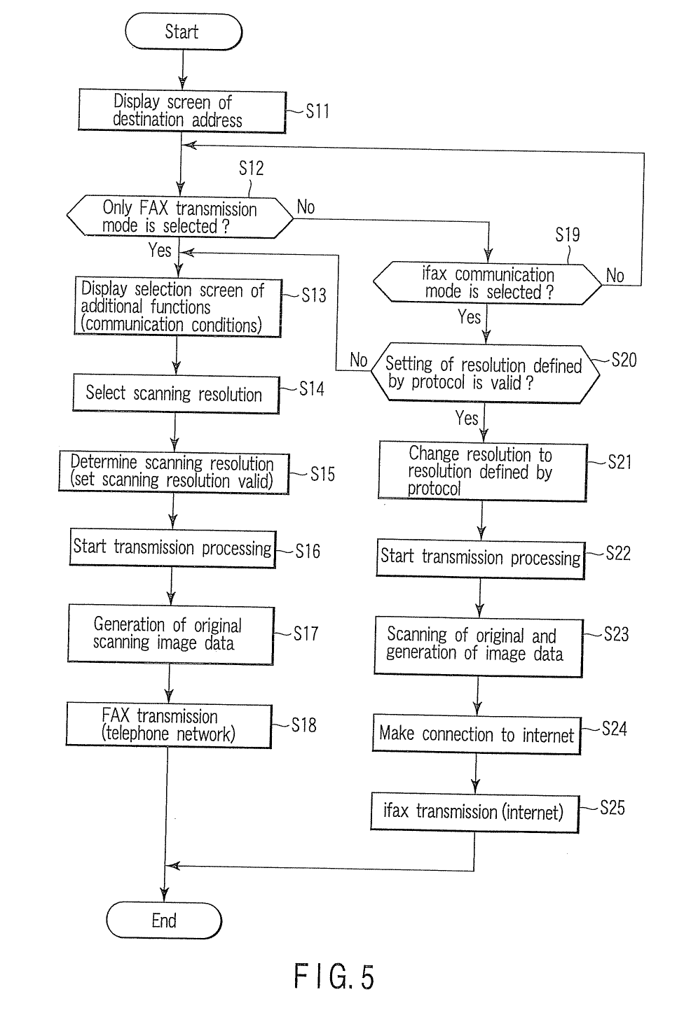

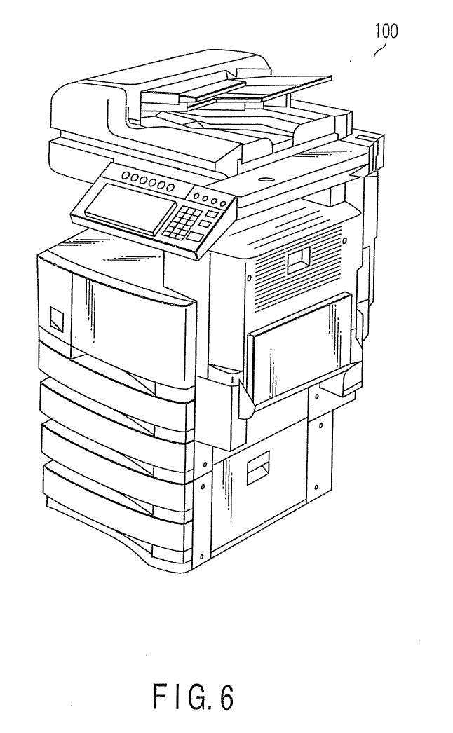

Transmission processing in the image forming apparatus 1 in which the initial setting of ifax is completed will be explained. Ifax transmission processing in the fax communication unit will be explained with reference to display examples of an operation panel and a screen (a touch panel) shown in FIGS. 4A to 4E and a flowchart shown in FIG. 5.

First, the user sets an original to be transmitted on a tray for scanning and selects a fax communication unit (FAX and/or ifax) that transmits the original. Specifically, the user depresses a [FAX] button shown in FIG. 4A. According to the depression of this [FAX] button, a first registration screen of a destination address table shown in FIG. 4B is displayed (step S11). Registered customer names displayed in this destination address table are displayed in a registration number order or alphabetical order. Beside the customer names, an icon indicating that both or one of a FAX number and an E-MAIL address for ifax is registered is displayed.

In this registration screen, the user touches a [FAX] icon to select a FAX transmission mode. The image forming apparatus 1 determines whether only the FAX transmission mode is selected (step S12). When only the [FAX] icon is touched in this determination (YES), the FAX transmission mode is selected. A transmission procedure of the FAX transmission mode is the same as the conventional operation of FAX communication. First, the user performs setting of original scanning resolution. However, when the resolution set in advance on the apparatus side as normal setting is acceptable, it is unnecessary to perform setting operation every time original scanning resolution is set.

The user touches an [OPTION] icon displayed on a registration screen shown in FIG. 4B to cause the image forming apparatus 1 to display a selection screen for additional functions (communication conditions: scanning resolutions) shown in FIG. 4C (step S13). In this selection screen, three icons of a [U-FINE (ultra-fine)] mode, a [FINE (fine)] mode, and a [STANDARD (ordinary)] mode are displayed as scanning resolutions. The user selects scanning resolution (step S14). Here, the user touches [U-FINE] icon to reverse display and touches an [ENTER] icon to determine the selection (step S15). In FIG. 4C, an example in which [U-FINE (ultra-fine)] of resolution 400 dpi is selected is shown. As this setting of desired resolution, for example, when the resolution is normally used, the resolution may be always set as certain standard resolution to allow the user to omit the setting of resolution.

Subsequently, the user depresses a [START] switch provided in an operation panel shown in FIG. 4E to start original scanning processing (step S16). The original set on the tray is conveyed to the scan unit 2, information (characters and images) described in the original is optically scanned by the CCD unit 21 and image data is generated (step S17). This image data is transmitted to a FAX apparatus of a designated customer by the FAX unit 10 through a telephone network (step S18).

When only the FAX transmission mode is not selected in step S12 (NO), the image forming apparatus 1 determines whether an [E-MAIL] icon shown in FIG. 4D is touched and the ifax transmission mode is selected (step S19). At this point, the selection of the ifax transmission mode includes a case in which the ifax transmission mode is selected after the FAX transmission mode is selected and, conversely, a case in which the FAX transmission mode is selected after the ifax transmission mode is selected.

In this embodiment, setting conditions of the ifax transmission mode are given priority. Therefore, in the initial setting of the ifax scanning processing described above, in [ifax RESOLUTION], the image forming apparatus 1 determines whether [ON] is set, i.e., whether application of setting of the resolution defined by the protocol is valid (step S20). When the application of the setting is valid in this determination (YES), the resolution conforming to the protocol is applied (step S21). At this point, for example, even if the [U-FINE (ultra-fine)] mode is set in the FAX mode, the resolution conforming to the protocol is applied. On the other hand, when the application of the setting is not valid (NO), the user shifts to step S13 and sets desired resolution.

Subsequently, the user depresses a [START] switch provided in an operation panel shown in FIG. 4E to cause the image forming apparatus 1 to start the transmission processing (step S22). First, scanning of the original is started, the original set on the tray is conveyed to the scan unit 2, information (characters and images) described in the original is optically scanned by the CCD unit 21, and image data of the resolution conforming to the protocol is generated (step S23). Thereafter, the external interface unit 13 makes connection to the Internet (step S24). The image data is transmitted from the external interface unit 13 to a personal computer or an apparatus having an ifax communication unit of a designated customer through the Internet (step S25).

According to this embodiment explained above, the ifax communication unit belonging to the category of E-MAIL can set original scanning resolution to match an image quality according to the resolution defined by the protocol of the Internet (an ifax protocol image quality) at the time of creation of the destination address table or at any time. While application of the scanning resolution is valid, when the user selects transmission of image data by the ifax transmission (E-MAIL) mode, even if the original scanning resolution is set to another resolution in the FAX mode or the like, the resolution is changed to the resolution defined by the protocol. Therefore, it is possible to prevent deterioration in an image quality due to time for converting an image from ultra-fine to fine and conversion processing.

Moreover, since selection for setting the application of the resolution defined by the protocol valid or invalid is possible, it is possible to expect improvement of customization according to uses.

In the embodiment described above, setting of the resolution defined by the protocol in the ifax transmission is explained. However, there are various other communication conditions.

It is possible that, depending on a file format of image data to be transmitted, the ifax transmission (E-MAIL) through the Internet may not applicable to an apparatus (a personal computer or a FAX apparatus) owned by a partner who receives the ifax transmission. A situation occurs in which image data received cannot be opened and displayed on a display or cannot be print-outputted to a recording sheet. Thus, the image forming apparatus has a function of converting the image data into an image file format (jpg, TIFF, etc.) designated out of plural file formats. This conversion of an image file format is selected and set according to an apparatus at a transmission destination. The setting of an image file format is performed together with setting of the resolution defined by the protocol by providing an item in the destination address table in the initial setting of the ifax scanning processing.

In the explanation of this embodiment, there is one transmission destination of the ifax transmission. However, it is also possible to set plural transmission destinations and transmit image data to the plural transmission destinations simultaneously.

As explained above, it is possible to provide the image forming apparatus having the Internet fax communication unit that changes setting to the communication conditions including the resolution level defined by the protocol of the Internet when the fax communication of image data through the Internet is selected and the image forming method for the image forming apparatus.

What is claimed is:

1. An image forming apparatus having a fax communication function comprising:
an image generating unit configured to generate image data from an original in which information is described;
a FAX communication unit configured to communicate the image data through a telephone network;
an ifax communication unit configured to communicate the image data through the Internet; and
a control unit configured to include a destination address table in which communication conditions including plural desired resolutions in the image data and resolution defined by a protocol of the Internet are set, wherein
when communication by the ifax communication unit is instructed, the resolution defined by the protocol is applied to resolution of scanning of the original by the image generating unit and the image data to be transmitted.

2. The image forming apparatus according to claim 1, wherein the control unit sets, when the setting of the resolution defined by the protocol is made invalid and the communication by the ifax communication unit is instructed in the destination address table, the resolution of the scanning of the original by the image generating unit and the image data to be transmitted to resolution selected out of the desired plural resolutions.

3. The image forming apparatus according to claim 2, wherein
the destination address table is constituted by registering at least one of FAX numbers for the FAX communication unit and addresses for the ifax communication unit incidentally to names of destinations, and
under communication conditions in which the addresses are registered and the application of the resolution defined by the protocol of the Internet is set valid, in the control unit, when communication by the ifax communication unit is instructed, the resolution defined by the protocol is applied to the resolution of the scanning of the original by the image generating unit and the image data to be transmitted regardless of the resolution that has been set.

4. The image forming apparatus according to claim 3, wherein the resolution defined by the protocol in the Internet is set to 200 dpi “detail”.

5. The image forming apparatus according to claim 1, wherein
the destination address table further includes a selection table of selectable plural image file formats, and
the control unit converts the image data generated by the image generating unit into a designated image file format.

6. An image forming method in an image forming apparatus having a fax communication function comprising:
generating, using an image generating unit, image data from an original in which information is described; and
communicating the image data through the Internet using an ifax communication unit, wherein
without operation for changing resolution by a transmitting person, using a destination address table in which communication conditions including resolution defined by a protocol of the Internet are set, resolution defined by the protocol is applied to resolution of scanning of the original by the image generating unit and the image data to be transmitted instead of resolution set originally.
